(19) United States
(12) Patent Application Publication
(10) Pub. No.: US 2010/0100017 A1
(43) Pub. Date: Apr. 22, 2010

(54) Motion therapy system

(76) Inventor: Pirko Maguina, Sacramento, CA (US)

Correspondence Address: Olson & Cepuritis, LTD., 20 NORTH WACKER DRIVE, 36TH FLOOR, CHICAGO, IL, 60606, US

(21) Appl. No.: 12/311,665

(22) PCT Filed: Oct. 11, 2007
(86) PCT No.: PCT/US07/21769

§ 371 Date: Nov. 2, 2009

Related U.S. Application Data
(60) Provisional application No. 60/851,204, filed on Oct. 12, 2006.

(51) Int. Cl. A61H 9/00

(52) U.S. Cl. 601/152; 601/151

(57) ABSTRACT

Motion therapy systems include an underlying first inflatable member or sleeve which surrounds a patient's body portion, and is at least partially surrounded by an overlying second inflatable member. The first inflatable member provides position control, load dispersion and cushioning for a patient, providing a buffering between the patient and the second inflatable member which is repeatedly inflated and deflated to impart motion to the patient's body portion. The first inflatable member can include a plurality of chambers that are sequentially inflated. The systems may be used, for example, with a patient's upper and lower extremities to minimize the development of pressure ulcers in patients who are relatively immobile and to reduce the risk of blood clot formation.

### CROSS-REFERENCE TO RELATED APPLICATION

This application claims the benefit of U.S. Provisional Application for Patent Ser. No. 60/851,204, filed on Oct. 12, 2006, which is incorporated herein by reference.

### FIELD OF THE INVENTION

The present invention relates to a motion therapy system and, in particular, to a device for moving and supporting a body portion of an immobile patient to prevent tissue disorders that can develop due to lack of body movement.

### BACKGROUND OF THE INVENTION

As is well known, bed-ridden or wheelchair-bound patients who are unable to perform even a modest amount of movement frequently develop decubitus ulcers or pressure sores/ulcers that can result from the development of necrotic tissue. This can complicate the patient's recovery, and places an added burden on the care giver. In extreme cases, surgical debridement and skin grafting of the lesions are required. This condition can affect a wide variety of body portions, especially the torso and upper and lower extremities.

In particular, pressure ulcers can develop when soft tissue is compressed between the surface of a bed or chair and a bone of the patient. Common sites for the development of pressure ulcers for an individual confined to a wheelchair include the shoulder blade, the elbow, the sacrum (a large, triangular bone adjacent the lower part of the vertebral column), the ischial tuberosity (the lower posterior portion of the hip bone), the posterior knee, and the foot, in particular, the heel. Bed-ridden individuals can develop pressure ulcers at the above sites and also at the dorsal thoracic area, the iliac crest (the upper portion of the hip bone), the trochanter (the upper portion of the femur), the anterior knee and the malleolus (the ankle) depending on how the individual is positioned.

Patients with immobile limbs, such as elderly, debilitated or sedated patients as well as diabetics can suffer significant skin damage due to circulatory deficiency and are particularly prone to pressure ulcers after only a few hours of immobile bed rest. A continued lack of adequate blood flow, and the resulting lack of oxygen, can lead to cell death and necrosis.

Successful treatment must involve relieving pressure on the affected area. Various types of devices are currently available for that purpose including heel pads, elbow pads, gel flotation mattress or chair pads that disperse pressure over a larger skin surface area, alternating pressure mattresses that contain sections which inflate and deflate to change areas of pressure, convoluted foam mattresses with alternating areas of depression and elevation, and air-fluidized beds that support the patient at a subcapillary pressure point and provide a therapeutic airflow.

One accepted method of reducing the risk of forming pressure ulcers involves moving or turning the patient on a regular basis, for example, every two hours or so. However, the effectiveness of this approach depends on the attentiveness and time constraints of the care giver, and, of course, will vary depending on the situation.

Another concern with bed-ridden individuals (for example, post-surgical patients) is preventing Deep Vein Thrombosis (DVT) and Pulmonary Embolism (PE) due to inadequate venous blood flow. In a mobile individual, venous blood flow is routinely stimulated by muscle contractions during movement of the body portion. However, an immobile individual can experience inadequate blood flow as a result of inactivity with the inherent risk of venous blood pooling and clot formation. Sequential compression devices have been developed for different body parts to stimulate blood flow, primarily in the legs. These devices operate by increasing local pressure in a sequential fashion to promote the return of venous blood.

However, when used on an immobile patient, sequential compression devices do not relieve the pressure applied, for example, to heels and other body parts of the inactive individual. Moreover, sequential compression devices, when used on a leg, can interfere with other therapeutic treatments such as conventional heel pads.

As a result, significant difficulties are encountered when both deep vein thrombosis and pressure sores must be prevented. This is a common scenario, since the population at risk for both is the same, namely the debilitated, bed-ridden or otherwise immobile patient. There is a need for an improved device for moving and supporting a body portion of an immobile patient to prevent the development of pressure sores. There is also a need for an improved device that serves the dual purpose of reducing the risk of developing pressure sores and reducing the risk of deep vein thrombosis.

### SUMMARY OF THE INVENTION

The present invention provides a novel and improved motion therapy system for preventing tissue deterioration occasioned by a lack of body movement. In one embodiment, the system provides a patient with several forms of relief. The motion therapy system includes an inflatable member defining at least one chamber, operatively associated with a body portion to be treated. A connection device is provided for connecting the inflatable member to a control assembly for a pressurized fluid source. The pressurized fluid source, in conjunction with the control assembly, repeatedly inflates and deflates the inflatable member, changing its volume, and in particular, its cross-sectional area. When the inflatable member is positioned between the support surface (e.g., the surface of a bed or chair) and the body portion to be treated, the body portion is moved back and forth or up and down.

Thus, pressure otherwise applied to the body portion upon contact with the support surface is reduced as closely adjacent body portions are supported by the inflatable member. The use of an inflatable member allows supporting pressure to be gently spread across adjacent portions of the patient's body, and intimate contact over a greater portion of the patient's body is made possible. Further relief is provided by repeatedly inflating and deflating the inflatable member, thus imparting motion to the body portion being treated, as the body portion is moved back and forth between a first position and a second position. The range and rate of motion can be readily varied using conventional equipment already available to medical staff.

In a second embodiment, the present invention provides enhanced position control with the use of two or more inflatable members. In this embodiment, the invention includes a device for moving and supporting a body portion, comprising a first inflatable member for receiving and surrounding the body portion. The first inflatable member defines at least one first chamber for inflation, so as to securely hold the device around the patient's body portion. A second inflatable member (similar to the inflatable member of the first embodiment above) is operatively associated with the first inflatable member and defines at least one second chamber. A connection device is provided for connecting the first and the second inflatable members to a control assembly for a pressurized fluid source that selectively inflates one or both of the inflatable members. Upon its inflation, the first inflatable member is gently but firmly positioned about the body portion and upon inflation of the second inflatable member, the body portion to be treated is moved by the gentle, controlled rising and falling motion of the second inflatable member. The first inflatable member is preferably connected to the second inflatable member, and thus fixes and maintains the location of the second inflatable member, as the second inflatable member is repeatedly inflated and deflated. If desired, the first inflatable member may be repeatedly inflated and deflated, as well.

As with the first embodiment, the rate of movement of the body portion being treated may easily be varied using known commercially available equipment. The range of movement is also easily controlled, as the body portion being treated is being moved from a first position to a second position. If desired, the first inflatable member may be arranged so as to enhance blood flow through the body portion. For example, the inflatable member can include a plurality of chambers that are sequentially inflated. As a further alternative, the first inflatable member can include an opening to define an area of the device that does not contact the body portion. This opening could expose a portion of the patient's skin prone to pressure ulcers or the location where a pressure ulcer previously developed.

As mentioned, the present invention can be readily used in conjunction with conventional equipment already available to medical staff. Accordingly, when the pressurized fluid source selectively inflates the first inflatable member to hold the body portion, selective inflation and deflation can be provided for the second inflatable member to move the body portion back and forth between a first position and a second position. The system provides cushioning and improved support for the body portion being treated. As in other embodiments, the body portion is supported over an enlarged area, using inflatable members that readily conform to the patient's anatomy. Positioning of the applied force is maintained by the first inflatable member, that gently but firmly engages the patient's body.

Improved position control is also provided in another embodiment of the present invention that provides, either inflatable or not, a device for moving, supporting and buffering a body portion being treated. The device includes a holding member for receiving and surrounding the body portion, and an inflatable member operatively associated with the holding member, defining at least one chamber. A connection device is provided for connecting the inflatable member to a control assembly for a pressurized fluid source that repeatedly inflates and deflates enlarging the size of the inflatable member so as work against a support surface to move the body portion back and forth between a first position and a second position as mentioned. The holding member can be made non-inflatable, or alternatively, can be made to be inflatable, with coupling to the pressurized fluid source for inflation.

At times, the improved position control provided by an extra inflatable member or noninflatable support member may not be needed. In these instances, the present invention provides a device for repeated movement of a body portion, comprising an inflatable member operatively associated with the body portion defining at least one chamber, and a connection device for connecting the inflatable member to a control assembly for a pressurized fluid source that repeatedly inflates and deflates the inflatable member to move the body portion back and forth between a first position and a second position.

Thus, the present invention includes a number of embodiments of devices for moving and supporting a body portion of a patient to reduce the risk of developing pressure ulcers and related devices that both reduce the risk of developing pressure ulcers and deep vein thrombosis.

### BRIEF DESCRIPTION OF THE DRAWINGS

In the drawings,

FIG. 1 is a schematic perspective view illustrating several embodiments of a motion therapy system according to the present invention;

FIG. 2 is a perspective view of additional embodiments of the motion therapy system;

FIG. 3 is a cross-sectional view taken along the plane 3-3 of FIG. 2;

FIGS. 3a-c are similar to FIG. 3 but show additional alternative embodiments for construction of individual first and second inflatable members;

FIG. 4 is a cross-sectional view taken along the plane 4-4 of FIG. 2;

FIG. 5 is a an elevational perspective view of an additional embodiment of the motion therapy system;

FIG. 6 is an elevational view of the motion therapy system of FIG. 5 in an inflated position;

FIG. 7 is a schematic cross-sectional view taken along the plane 7-7 of FIG. 5;

FIG. 8 is a schematic cross-sectional view taken along the plane 8-8 of FIG. 6; and

FIG. 9 is a schematic diagrammatic view of a control system for a motion therapy system according to the present invention.

### DESCRIPTION OF THE PREFERRED EMBODIMENTS

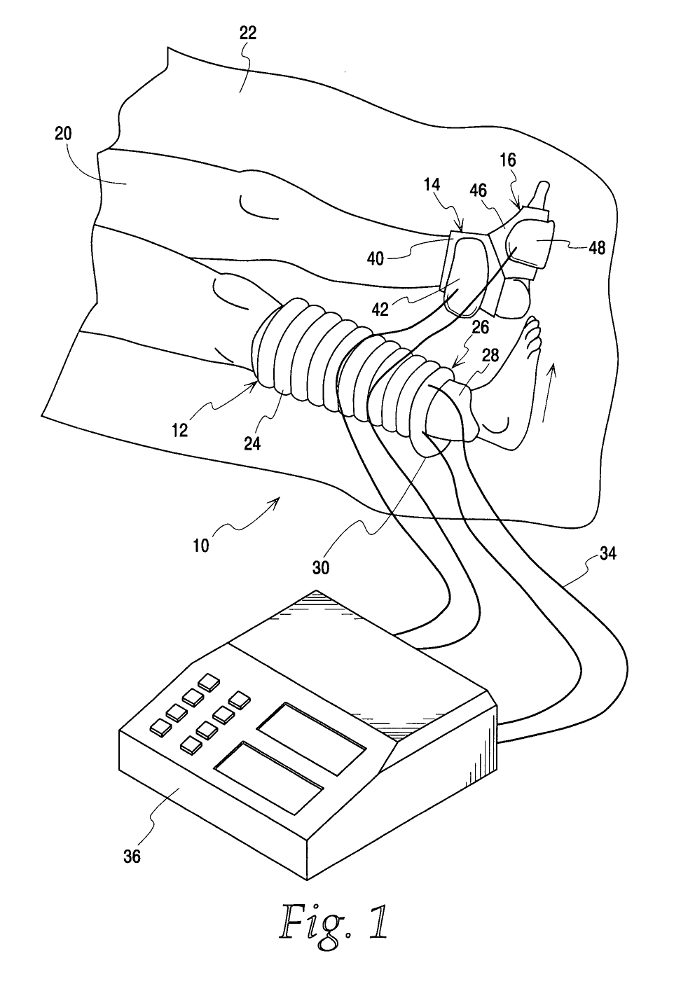

FIG. 1 illustrates several embodiments of a patient motion therapy system according to the present invention which is generally indicated by the numeral 10. For illustrative purposes, three treatment/therapeutic systems 12, 14 and 16 are shown. Normally, the use of more than one or two treatment systems at one time would not be expected. Each treatment system operates independently to provide movement of a patient's body part that is needed for therapeutic or prophylactic intervention. In particular, the legs 20 of a patient reclining on a bed, table or other support surface 22 are shown. In one embodiment, a first treatment system 12 incorporates two combined systems, a sequential pressurization system 24 and a motion therapy system 26 in a dual purpose device that reduces the risk of deep vein thrombosis and reduces the risk of developing heel pressure ulcers.

Basically, sequential pressurization system 24 includes a plurality of individual cylindrical pressure cells arranged in a planar array so as to encompass a portion of the patient's leg. System 24 operates by increasing local pressure in a sequential fashion so as to promote the return of venous blood. A cylindrical pressure cell located closest to the patient's foot is operated first to compress a local portion of the patient's leg. A sequential pressurization of individual cylindrical pressure cells advances towards the patient's knee, in a known manner, to urge blood flow away from the patient's foot, so as to prevent deep vein thrombosis, as is known in the art.

In addition to promoting the circulation of venous blood, sequential inflation of the individual pressure cells of system 24 can, for example, also promote lymph drainage from a patient's leg. The lymphatic system includes a series of capillaries and vessels that drain lymph, a watery fluid that removes bacteria and foreign materials from the blood, for filtering at various lymph nodes throughout the body. Lymph is pumped in and out of these vessels by constriction and muscle movement. Without proper drainage, lymphedema or a painful swelling of the affected area results. Sequential pressurization, as described above, is a useful therapy to assist lymph (and interstitial fluid) drainage from limbs.

However, use of system 24 alone will not reduce the risk of developing heel pressure ulcers. Pads, pillows and other static devices are routinely employed to distribute applied loads. But, without the time-consuming intervention of trained personnel, benefits, such as those provided by a continuing change in body position, have not been readily achievable. Further, it is difficult to provide different types of therapeutic intervention around a relatively small body portion, such as the area immediately surrounding the ankle.

The present invention, however, overcomes these and other difficulties by incorporating motion therapy system 26 into the overall arrangement of therapeutic system 12. Included in motion therapy system 26 is a first inflatable member 28 and a second inflatable member 30 which is preferably disposed outside or at least partially surrounding the first inflatable member 28. The first inflatable member 28 serves as an inflatable cuff or sleeve surrounding, cushioning and protecting the area adjacent the patient's foot and ankle. If desired, any of the inflatable cuffs known today can be employed. A first connection line 34 connects the first inflatable member 28 to a control unit 36 that provides a desired inflation pressure for a number of inflatable components, including the first inflatable member 28.

Motion therapy system 26 further includes the second inflatable member 30 lying outside of first inflatable member 28 so as to at least partially surround the first inflatable member. As shown in FIG. 1, the second inflatable member 30 completely surrounds the lower portion of the patient's leg. If desired, the second inflatable member 30 can only extend below the patient's leg. The second inflatable number 30 is connected to control unit 36 so as to receive inflation pressure therefrom. Preferably, control unit 36 operates to sequentially inflate and deflate the second pressure member 30 in a repeated sequence, so as to repeatedly raise and lower the patient's heel. If desired, the patient's heel may be moved random distances within a range, or alternatively, may be moved back and forth a prescribed distance between a first position and a second position. The repeated back-and-forth movement of the patient's body portion may occur at regular cyclic intervals, or may occur in a random timing pattern, as may be desired. As indicated in FIG. 1, the second inflation member 30 protrudes beyond both the first inflation member 28 as well as sequential pressurization system 24, so as to control movement of the patient's body portion.

The first inflatable member 28 provides position control for the second inflatable member 30. Accordingly, it is generally preferred that the first inflation member 28 provide at least a minimum gripping pressure to avoid shifting of the position of the second inflatable member 30 with respect to that portion of the patient's body receiving motion therapy. The second inflatable member 30, in at least part of its operation, bears the weight of the patient's lower leg, lifting the patient's lower leg so as to bring the patient's heel out of contact with support surface 22. In doing so, the second inflatable member 30 necessarily applies pressure to the patient's leg in order to accomplish the lifting motion. Rather than apply this lifting pressure directly to the patient's leg, the second inflatable member 30 applies pressure to the first inflatable member 28.

In this manner, the first inflatable member 28 receives the lifting force and distributes it over an increased portion of the patient's body, while cushioning the patient's body against the applied force. If desired, control unit 36 can be operated so as to perform changes in inflation pressure as slowly as may be desired, in order to further limit the time rate of force applied to the patient's leg. Of course, the first inflatable member 28 also limits the time rate of change of applied force and acts to dampen the applied force. If desired, the inflation properties of the first and the second inflation members may be adjusted as desired by changing the material properties chosen, so as to alter the amount of inflation volume for a given the change of inflation pressure, as well as altering the time-based response of the material to varying inflation pressures.

Although only a single cell has been shown for the second inflatable member 30, multiple pressure cells can be employed, and these cells can be dimensioned as desired. For example, although the second inflatable member 30 is shown having a toroidal shape with a relatively large difference between the primary (toroidal) and secondary (cross-sectional) radii, a different shape such as one covering a substantial portion of the patient's leg, can be used. Also, the second inflatable member 30 can be sized differently from what is shown in FIG. 1. For example, the first inflatable member 28 can be of a substantially smaller size, matching the size of the inside surface of the second inflatable member 30. Further, either the first or the second inflatable members or both, can be provided with openings to allow pressure relief for a specific body portion, or to provide access to the patient's body which would otherwise be covered by the system or systems. Pressure relief may be beneficial, for example, when the motion therapy system covers a person's joint, such as an elbow or knee, or the heel. While it is generally preferable to use air as the inflation medium, virtually any fluid, liquid or gas, can be used to inflate the first and the second inflatable members. Also, while it is generally preferable to employ inflation fluids at room temperature, fluids at other temperatures can be employed, as well.

Referring again to FIG. 1, motion therapy system 10 includes treatment systems 14, 16 which, for illustrative purposes, are employed adjacent one another on the patient's other leg and foot. As shown, treatment systems 14, 16 provide different types of motion therapy for the patient. Treatment system 14 includes an underlying primary or first inflatable member 40 and an overlying secondary or second inflatable member 42. The primary and secondary inflatable members 40, 42 operate in a manner similar to the first and second inflatable members 28, 30, as described above. The primary inflatable member 40 contacts the patient's leg to provide position control, force dispersion and cushioning. Thus, the primary inflatable member 40 protects the patient's body portion from the action of the secondary inflatable member 42 as it is repeatedly inflated and deflated to raise and lower the patient's heel and lower leg.

The treatment system 16 also provides motion therapy for the patient. Included are first and second inflatable members 46, 48, which also operate in a manner similar to the first and the second inflatable members 28, 30, as described above. Motion therapy system 16 can bear against a support surface (not shown) located at the foot of the patient's bed, for example. For those patients suffering from the effects of trauma to an ankle, for example, motion therapy system 16, when operated to repeatedly inflate and deflate the second inflatable member 48, repeatedly moves the patient's foot back-and-forth, between first and second positions, thus preventing scarring to a patient's muscles and tendons, during the healing process. Motion therapy system 16 shown in FIG. 1 illustrates one of the many possible applications of systems according to principles of the present invention.

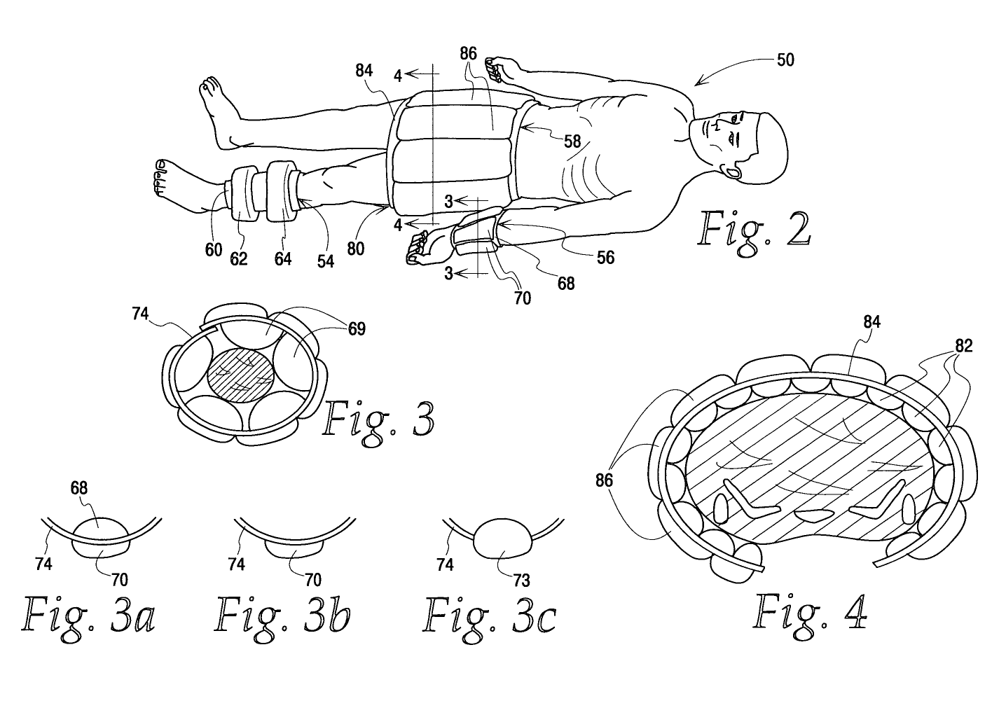

As will now be appreciated, motion therapy systems can be readily adapted to numerous portions of the patient's body. With reference to FIG. 2, a variety of motion therapy systems are shown applied to various portions the body of a patient 50. Included are a motion therapy system 54 applied to the patient's left leg, a motion therapy system 56 applied to the patient's forearm and a motion therapy system 58 applied to the patient's waist and hips.

Motion therapy system 54 includes a first inflatable member 60 and a pair of second inflatable members 62, 64. The first inflatable member 60 contacts the patient's lower leg and underlies both second inflatable members 62, 64 to provide position control, load dispersion and cushioning for the second inflatable members. If desired, both second inflatable members 62, 64 can be operated together, being fed from a common pressure source, or they can be operated independently, being connected to different channels of a pressure control unit, for example. With a patient in a recumbent position, second inflatable members 62, 64 provide motion therapy for the patient's lower leg and foot. If desired, the second inflatable members 62, 64 can provide different ranges of motion, and can be operated one at a time, or to the exclusion of the other, or alternately, as may be desired.

Motion therapy system 56 includes a first inflatable member 68 underlying a plurality of circumferentially-spaced second inflatable members 70. As described above, the first inflatable member 68 underlies the second inflatable members 70 and provides position control, load dispersion and cushioning therefor. If desired, the second inflatable members 70 can be operated individually or in combination with one another to provide motion therapy for the patient's forearm. Although the second inflatable members 70 are illustrated as a plurality of spaced-apart pressure cells, the pressure cells could be located contiguous with one another, or they could be arranged to extend in a circumferential direction, if desired. Further, with reference to FIG. 3, the first inflatable member 68 is illustrated as a plurality of inflatable cells 69. If desired, the individual cells 69 could be replaced by one or more cells extending in a circumferential direction. Also shown in FIG. 3 is an optional web 74 to which the first and the second inflatable members are mounted. Web 74 preferably includes a fastening device such as conventional hook and loop fasteners to secure the web against outward hoop forces that arise when the inflatable members are pressurized.

FIGS. 3a-c illustrate several additional alternative embodiments for construction of the first inflatable member 68 and the second inflatable member 70. The inflatable members can define various shapes and configurations, and are not limited to those illustrated. In FIG. 3a, first and second inflatable members are positioned on opposite sides of the optional web 74. The first inflatable member 68 contacts the body portion and the second inflatable member 70 provides motion therapy. FIG. 3b shows the optional web 74 including a second inflatable member 70 only. FIG. 3c shows an inflatable portion 73 that functions both as a first and second inflating member. In each embodiment, the optional web 74 can be included or eliminated, as desired.

In another embodiment, the motion therapy system 58 includes a first inflatable member 80 which, as can be seen in the cross-sectional view of FIG. 4, comprises a plurality of inflatable pressure cells 82 which are mounted to a web 84. Also mounted to web 84 are a plurality of a second inflatable members 86 which can be inflated and deflated by a pressure source and control (not shown) to provide motion therapy for a patient's midsection. The pressure cells 82 of the first inflatable member 80 provide position control, cushioning and load dispersion for the second inflatable members 86.

The web 84 may be provided with a pair of interlocking open ends so as to allow the motion therapy device to be conveniently wrapped about a person's body. Alternatively, the motion therapy device may be provided in the form of an unbroken cylinder or sleeve which is slipped about the patient's body, and the first inflatable member is inflated to achieve a desired fit. If desired, the pressure cells of the first and/or the second inflatable members can be replaced with one or more pressure cells extending in a circumferential direction. Further, if desired, the web 84 can be omitted, with the first and the second inflatable members being joined together.

In FIG. 2, the motion therapy system is illustrated having first and second inflatable members completely surrounding the patient's midportion. If desired, the first and second inflatable members can be limited to the patient's backside, with the remaining inflatable members being unused or removed, as may be desired. It is generally preferable, although not required, that the motion therapy system be provided with some means of completely encircling the patient's midsection so as to withstand outwardly directed forces which would otherwise tend to dislocate or displace the motion therapy system from around the patient's body.

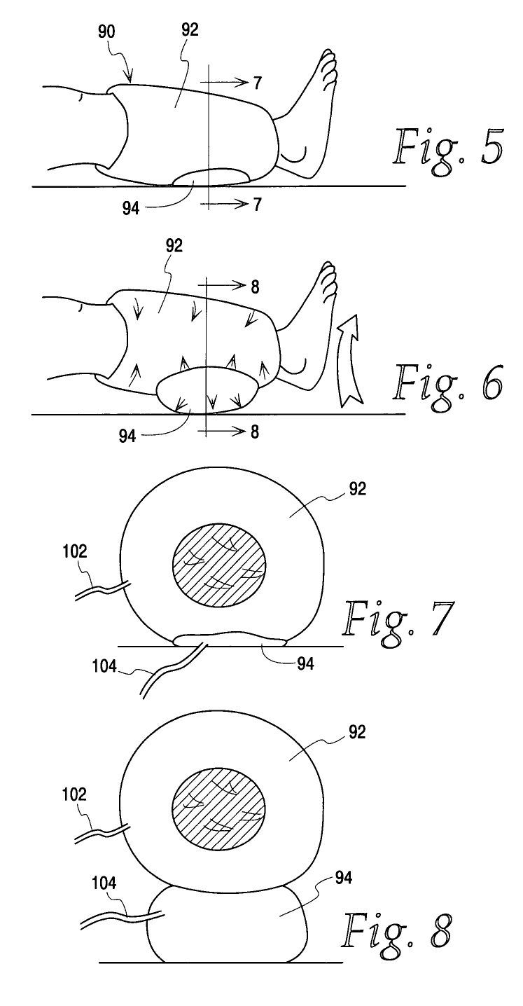

Turning now to FIGS. 5-8, motion therapy system 90 includes first and second inflatable members 92, 94. The first inflatable member 92 surrounds a substantial portion of the patient's lower leg and provides position control, cushioning and load dispersion for the second inflatable member 94 located on the outside surface of first inflatable member 92. As can be seen, second inflatable member 94 covers a relatively small circumferential portion of the patient's leg. As illustrated, the second inflatable member is preferably positioned at the bottom or underside of the patient's leg, so as to work against gravitational forces applied thereto. As can be seen by comparing FIGS. 5 and 7 to FIGS. 6 and 8, the second inflatable member 94 has a volume expansion sufficient to raise the patient's heel above the support surface. As can be seen in FIGS. 7 and 8, connection lines 102, 104 are provided for inflation and deflation of the first and the second inflatable members 92, 94.

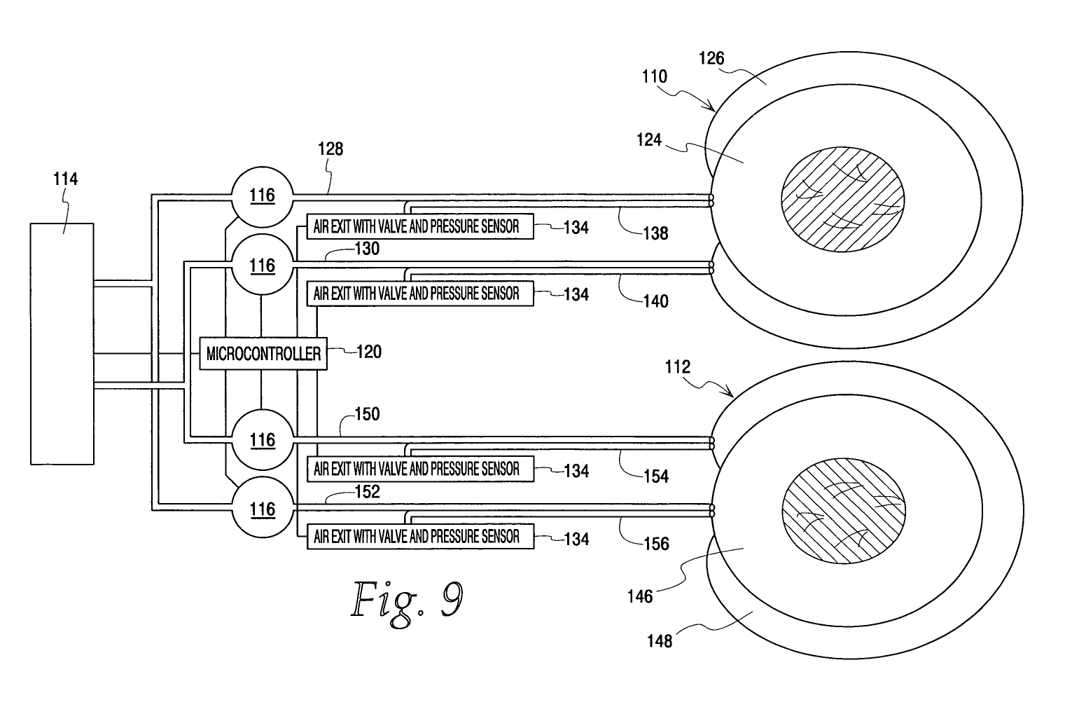

Referring now to FIG. 9, an example of a patient therapy system is shown in diagrammatic schematic form. Included are a pair of motion therapy systems 110, 112 coupled to a control unit 114 through a series of pressure control devices 116, which can comprise valves and/or pumps, for example. As shown in FIG. 9, pressure control devices 116 are connected to a microcontroller 120 that, in turn, is connected to control unit 114. If desired, microcontroller 120 can be incorporated into control unit 114.

Motion therapy unit 110 includes an underlying first inflatable member 124 and an overlying second inflatable member 126 coupled to their respective control devices 116 through lines 128, 130, respectively. In the arrangement illustrated, the first and the second inflatable members 124, 126 are monitored by pressure sensors in respective control units 134. Pressure signals are sent to the pressure sensors 134 through lines 138, 140. Control units 134 provide feedback signals to microcontroller 120 and/or control unit 114, which are used to adjust pressures in the first and second inflatable members to achieve desired pressure levels.

The second motion therapy system 112 is substantially identical to the first motion therapy system 110, and includes first and second inflatable members 146, 148 that are coupled to their respective control devices 116 by lines 150, 152. Pressure within the first and the second inflatable members is monitored by lines 154, 156, and feedback signals from pressure sensors in control units 134 are sent to microcontroller 120 and/or control unit 114. In one arrangement, control unit 114 includes one or more pressure sources that are regulated at 116, before establishing pressure levels in the first and the second inflatable members of motion therapy systems 110, 112. In another arrangement, control devices 116 comprise pumps operated under control of microcontroller 120 and/or control unit 114. If desired, control units 134 can comprise either open circuit or closed-circuit systems, with and without air exits, respectively. In addition, valves can be provided at control units 134 as may be desired.

Whatever specific control arrangement is provided, it can be seen that the motion therapy devices can be readily controlled by existing as well as purpose-built control equipment. For example, control arrangements are already in place for sequential compression devices, automated blood pressure reading devices and other equipment. It will be readily appreciated that motion control systems according to principles of the present invention can be coupled to existing control systems, thereby reducing investment cost as well as clutter in crowded operational areas.

The invention disclosed herein is, of course, susceptible of embodiment in many forms. Shown in the drawings and described herein are preferred embodiments of the invention. It is to be understood, however, that the present disclosure is an exemplification of the principles of the invention and does not limit the invention to the illustrated embodiments.

For example, the sequential inflation of the individual pressure cells of system 24 can also be used in postural drainage therapy. Postural drainage is a technique for loosening mucus in the airway whereby secretions are drained, by the effect of gravity, from one or more lung segments to the central airways where they can be removed by cough or aspiration. A number of different positions are routinely used to help drain mucus from different sections of the lungs. In most positions, the head and chest of the individual are positioned slightly lower than the rest of the body. However, tilting the individual from one side to the other can also be beneficial. The present motion therapy system can be used around the chest of an individual to assist in clearing secretions and alternating the areas of the lung placed in the most dependent position. Those areas receive less ventilation and tend to have most of the blood flow of the lung pooled in them. Postural drainage can be used with bed-ridden patients and is routinely used in the treatment of diseases such as cystic fibrosis.

For ease of description, the embodiments of the present motion therapy systems are described herein in their usual assembled positions as shown in the accompanying drawings and terms such as front, rear, upper, lower, top, bottom, inner, outer, horizontal, longitudinal, etc. are used herein with reference to this usual position. However, the systems may be manufactured, transported, sold or used in orientations other than that described and shown herein.

The foregoing description and the accompanying drawings are illustrative of the present invention. Still other variations in arrangements of parts are possible without departing from the spirit and scope of this invention.

What is claimed is:

1. A motion therapy system comprising:
a first inflatable member for receiving and surrounding a body portion, defining at least one first chamber;
a second inflatable member operatively associated with the first inflatable member defining at least one second chamber; and
a connection device for connecting the first and the second inflatable members to a control assembly for a pressurized fluid source that selectively inflates one or both of the inflatable members;
whereby, upon inflation, the first inflatable member is positioned about the body portion and the second inflatable member moves the body portion from a first position to a second position.

2. The system of claim 1 wherein, upon inflation, the first inflatable member enhances fluid flow through the body portion.

3. The system of claim 2 wherein the fluid is selected from blood or lymphatic or interstitial fluid (causal of edema).

4. The system of claim 3 wherein the first inflatable member includes a plurality of chambers that are sequentially inflated.

5. The system of claim 1 wherein the first inflatable member defines an opening not in contact with part of the body portion.

6. A device for operative association with a pressurized fluid source for moving and supporting a body portion comprising:
first and second inflatable members;
the first inflatable member for holding the body portion and for locating the second inflatable member with respect to the body portion, the first inflatable member including at least one first chamber;
the second inflatable member including at least one second chamber, operatively associated with the first inflatable member to move the first inflatable member and hence the body portion between a first and a second position; and
a connection device for connecting the first and the second inflatable members to a control assembly for a pressurized fluid source to control inflation of one or both of the inflatable members;
whereby the pressurized fluid source selectively inflates the first inflatable member to hold the body portion and selectively inflates and deflates the second inflatable member to move the body portion back and forth between a first position and a second position.

7. The device of claim 6 wherein upon inflation, the first inflatable member enhances blood flow through the body portion.

8. The device of claim 6 wherein the first inflatable member includes a plurality of chambers that are sequentially inflated.

9. A device for moving and supporting a body portion comprising:
a holding member for receiving and surrounding the body portion;
an inflatable member operatively associated with the holding member defining at least one chamber; and
a connection device for connecting the inflatable member to a control assembly for a pressurized fluid source that repeatedly inflates and deflates the inflatable member to move the body portion back and forth between a first position and a second position.

10. The device of claim 9 wherein the holding member is non-inflatable.

11. The device of claim 9 wherein the holding member is inflatable and is coupled to the pressurized fluid source for inflation.

12. A device for repeated movement of a body portion comprising:
an inflatable member operatively associated with the body portion defining at least one chamber; and
a connection device for connecting the inflatable member to a control assembly for a pressurized fluid source that repeatedly inflates and deflates the inflatable member to move the body portion back and forth between at least a first position and a second position.
